(19) United States
(12) Patent Application Publication
(10) Pub. No.: US 2009/0295972 A1
(43) Pub. Date: Dec. 3, 2009

(54) SOLID-STATE IMAGING DEVICE, DRIVING METHOD THEREOF, AND CAMERA

(75) Inventors: Hiroshi Hara, Hyogo (JP); Yoshiaki Kato, Shiga (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/434,173

(22) Filed: May 1, 2009

(30) Foreign Application Priority Data
May 29, 2008 (JP) 2008-141714

(51) Int. Cl. H04N 5/335

(52) U.S. Cl. 348/311; 348/E05.091

(57) ABSTRACT

In a solid-state imaging device, a VDr controls charge transfer performed by a column CCD such that: the column CCD consecutively transfers plural packets each of which is the charge transferred in well regions which are successive and segmentalized by barrier regions; a waiting period in which the charge transfer of the packets is halted is longer than a transfer period in which the charge transfer of the packets is performed; the charge transfer stages which operate as the barrier region are at least three adjacent stages among seven or more charge transfer stages in the waiting period; and a charge transfer stage in which a potential shape is inclined in a charge transfer direction is positioned most downstream among adjacent charge transfer stages which operate as the barrier region in the waiting period.

### BACKGROUND OF THE INVENTION

(1) Field of the Invention

The present invention relates to solid-state imaging devices, and particularly to a Charge Coupled Device (CCD) solid-state imaging device.

(2) Description of the Related Art

A CCD solid-state imaging device is generally used for a solid-state imaging device included in an imaging device such as a video camera and a digital still camera. In the CCD solid-state imaging device, signal charge generated in a photo diode using incident light is read by a column CCD, and transferred to a charge detection unit (FD unit) by the column CCD and a row CCD.

As to the CCD solid-state imaging device as described above, a technique for speeding up image signal output by performing pixel mixture is disclosed by, for example, Patent Reference 1 (Unexamined Patent Application Publication No. 2004-180284). The CCD solid-state imaging device includes at the final stage of the column CCD a transfer unit capable of controlling driving independently of column CCDs in other columns. Transferring signal charge from the column CCD to the row CCD is controlled independently for each column, and signal charge of plural pixels in the row direction are mixed in the row CCD.

### SUMMARY OF THE INVENTION

When an area of a CCD is reduced for miniaturizing the solid-state imaging device, a transfer-degraded spot is generated in a barrier region of the CCD due to a finishing of gate dimensions of the CCD, a subtle unevenness in a dopant profile, or a subtle unevenness in a gate insulating film. In a column CCD of a twelve-phase drive, for example, a low level driving pulse is applied to two adjacent drive electrodes V1 and V2 as shown in the potential distribution of the column CCD in FIG. 9 and a transfer-degraded spot (A in FIG. 9) appears in a barrier region under the two adjacent drive electrodes V1 and V2. A part of packets (signal charge transferred in well regions which are successive and segmentalized by the barrier regions) 400 transferred in a column direction is trapped in the transfer-degraded spot. When the transfer in the column direction is halted, the trapped signal charge is discharged and added to the packet accumulated in the well region. The solid-state imaging device disclosed in the Patent Reference 1 is affected by this phenomenon, so that the charge amount of the packets to be transferred varies. This will be described in detail by using a variation diagram of the potential distribution in the column CCD in FIG. 10.

In the solid-state imaging device of the Patent Reference 1, when performing pixel mixture (when nine-pixel mixture is performed), a waiting period in which the transfer in the column direction is halted appears after not one packet (the signal charge for one pixel) but three packets (the signal charge for three pixels) are transferred to the row CCD (FIG. 10(a)). Here, at the transfer-degraded spot (A in FIG. 10) in the barrier region between stages, a signal charge is trapped. The trapped signal charge is added to the packets accumulated in the well region while the transfer in the column direction is halted (FIG. 10(b)). When the transfer in the column direction is resumed, a part of packets which passes the transfer-degraded spot next is trapped in the transfer-degraded spot (FIG. 10(c)). The trapped signal charge is more likely to be discharged when transfer is halted for a longer time than the time necessary for transferring a packet for a single stage (the time necessary for the state of FIG. 10(d) to be changed to FIG. 10(e)), so that the next two packets are consecutively transferred in the column direction with hardly any effects received by the transfer-degraded spot. Therefore, the signal charge amount increases in some packets and decreases in other packets, so that the transferred signal charge amount varies. The variation of the signal charge amount results in a quality deterioration, such as unevenness in an image.

The present invention has been conceived in view of the above-described problem and aims to provide a solid-state imaging device capable of performing pixel mixture without causing quality deterioration such as unevenness in an image

In order to achieve the object described above, a solid-state imaging device according to the present invention includes: a plurality of photoelectric conversion elements arranged two-dimensionally; a plurality of column transfer units configured to transfer, in a column direction, charge generated in the photoelectric conversion elements; a row transfer unit configured to transfer, in a row direction, the charge transferred by the column transfer units; and a transfer control unit configured to control the charge transfer performed by the column transfer units, and in the solid-state imaging device, each of the column transfer units includes seven or more charge transfer stages each operating as a barrier region or a well region according to an applied voltage, the charge transfer stages include a first charge transfer stage in which a potential shape is inclined in a charge transfer direction, and the transfer control unit is configured to control the charge transfer performed by the column transfer units such that: the column transfer units consecutively transfer a plurality of packets each of which is the charge transferred in the well regions that are successive and segmentalized by the barrier regions; a waiting period in which the charge transfer of the packets is halted is longer than a transfer period in which the charge transfer of the packets is performed; the charge transfer stages which operate as the barrier region are at least three adjacent stages among the seven or more charge transfer stages in the waiting period; and the first charge transfer stage is positioned most downstream among the adjacent charge transfer stages which operate as the barrier region in the waiting period.

According to the above structure, the charge transfer stage positioned most downstream, among the adjacent charge transfer stages that operate as the barrier region in the waiting period, operates as the barrier region and the well region in which a potential shape is inclined in a charge transfer direction and generates a fringe electric field greater than a fringe electric field of the charge transfer stage in which the potential shape is not inclined, so that the signal charge is less likely to be trapped or not trapped in the transfer-degraded spot. Therefore, unevenness in the signal charge amount can be reduced. Further, signal charge trapped in a spot positioned between barriers in adjacent charge transfer stages that operate as the barrier region in the waiting period are not added to the adjacent well region from the transfer-degraded spot. As a result, the amount of transfer signal charge does not vary due to the signal charge trapped in the transfer-degraded spot as in the solid-state imaging device disclosed by the Patent Reference 1. Therefore, it is possible to perform pixel mixture without causing quality deterioration such as unevenness in an image.

Further, it is possible to suppress increase of dark current by minimizing the area of the well region and to suppress degradation of transfer efficiency when the signal amount is low.

Further, the transfer control unit may control the charge transfer performed by the column transfer units such that a charge transfer stage positioned closest to the row transfer unit, among the seven ore more charge transfer stages, operates as the well region after operating as the barrier region in the waiting period.

This provides a greater potential difference between the row transfer unit and the final stage of the column transfer unit, so that a packet can be transferred to the row transfer unit without causing residual transfer charge, thereby preventing degradation of transfer efficiency between the row transfer unit and the column transfer unit.

According to the present invention, it is possible to implement a solid-state imaging device capable of performing pixel mixture without causing quality deterioration such as unevenness in an image.

### FURTHER INFORMATION ABOUT TECHNICAL BACKGROUND TO THIS APPLICATION

The disclosure of Japanese Patent Application No. 2008-141714 filed on May 29, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a schematic structure of a camera according to an embodiment of the present invention.

FIG. 2A is a schematic diagram showing a structure of a solid-state imaging sensor according to the embodiment.

FIG. 2B is a schematic diagram showing a structure of a sort transfer unit.

FIG. 3 is a sectional view which shows a structure of a column CCD of a second column according to the embodiment.

FIG. 4A is a diagram which shows timing with which a signal for a single image is outputted according to the embodiment.

FIG. 4B is a diagram which shows timing of charge transfer between a column CCD and a row CCD.

FIG. 5 is a diagram which shows timing with which signals for a single image is outputted according to the embodiment.

FIG. 6 is a diagram which shows a charge transfer between the column CCD and the row CCD.

FIG. 7 is a variation diagram of a potential distribution which shows a transfer method of a packet of the column CCD of the second column according to the embodiment.

FIG. 8 is a variation diagram of a potential distribution which shows a transfer method of a packet of the column CCD of the second column according to the embodiment.

FIG. 9 is a diagram which shows packets being transferred in the column CCD that includes a transfer-degraded spot.

FIG. 10 is a diagram which shows packets being transferred in the column CCD that includes a transfer-degraded spot.

FIG. 11 is a diagram which shows timing of charge transfer between the column CCD and the row CCD.

### DESCRIPTION OF THE PREFERRED EMBODIMENT

A solid-state imaging device according to an embodiment of the present invention will be described below with reference to the drawings.

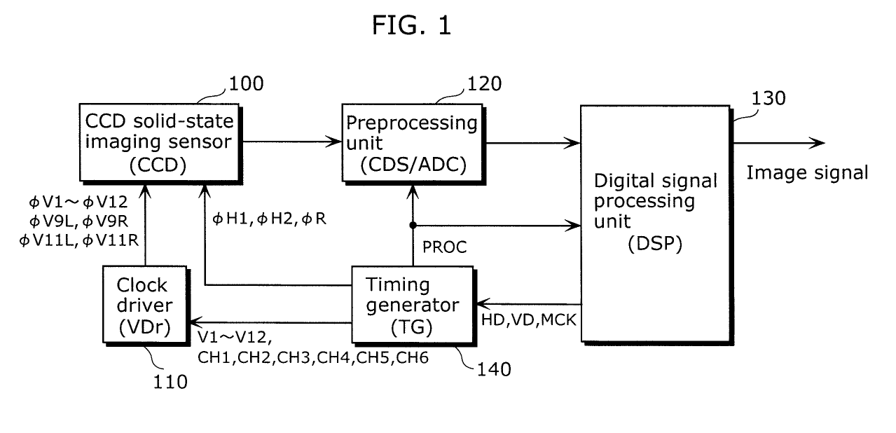

FIG. 1 is a block diagram which shows a schematic structure of an imaging device (camera) according to the present embodiment.

The camera includes: a CCD solid-state imaging sensor 100 that transfers signal charge resulted from photoelectric conversion of an incident light; a clock driver (VDr) 110; a preprocessing unit (CDS/ADC) 120 that performs correlated double sampling (CDS) and analog-digital conversion (ADC); a digital signal processing unit (DSP) 130 that interpolates a pixel, performs a brightness or a color-difference processing, and outputs an image signal; and a timing generator (TG) 140. The solid-state imaging sensor 100, the VDr 110, and the TG 140 are included in the solid-state imaging device of the present invention.

The VDr 110 is an example of the transfer control unit, and controls the charge transfer performed by the column CCDs such that: the column CCDs consecutively transfer a plurality of packets; a waiting period during which the charge transfer is halted due to a break after transferring plural packets is longer than a transfer period in which the charge transfer of the packets is performed; the charge transfer stages which operate as the barrier region are at least three adjacent stages among the seven or more charge transfer stages in the waiting period; and the charge transfer stage positioned most downstream among the adjacent charge transfer stages which operate as the barrier region in the waiting period is the charge transfer stage in which a potential shape is inclined in a charge transfer direction.

More specifically, the VDr 110 generates driving pulses φV1 to φV12, φV9R, φV9L, φV11R, and φV11L using logic signals V1 to V12 and CH1 to CH6 outputted from the TG 140 and supplies the column CCDs of the solid-state imaging sensor 100 with the driving pulses φV1 to φV12, φV9R, φV9L, φV11R, and φV11L, thereby controlling charge transfer performed by the column CCDs. The driving pulses φV1 to φ12, φV9R, φV9L, φV11R, and φV11L have three potentials which are a high-level potential V_{H}, a middle-level potential V_{M} that is lower than the potential V_{H}, and a low-level potential V_{L} that is lower than the potential V_{M}. For example, the driving pulses φV1 to φV12 are assumed to be pulses having three potentials which are 12V as the potential V_{H}, 0V as the potential V_{M}, and −6V as the potential V_{L}.

The TG 140 receives from the DSP 130 an input of each of the pulses of a row synchronization signal HD, a column synchronization signal VD, and a clock signal MCK, generates driving pulses φH1, φH2, φR, logic signals V1 to V12, and CH1 to CH6 used for driving the solid-state imaging sensor 100, and outputs a signal processing pulse PROC to the preprocessing unit 120 and the DSP 130.

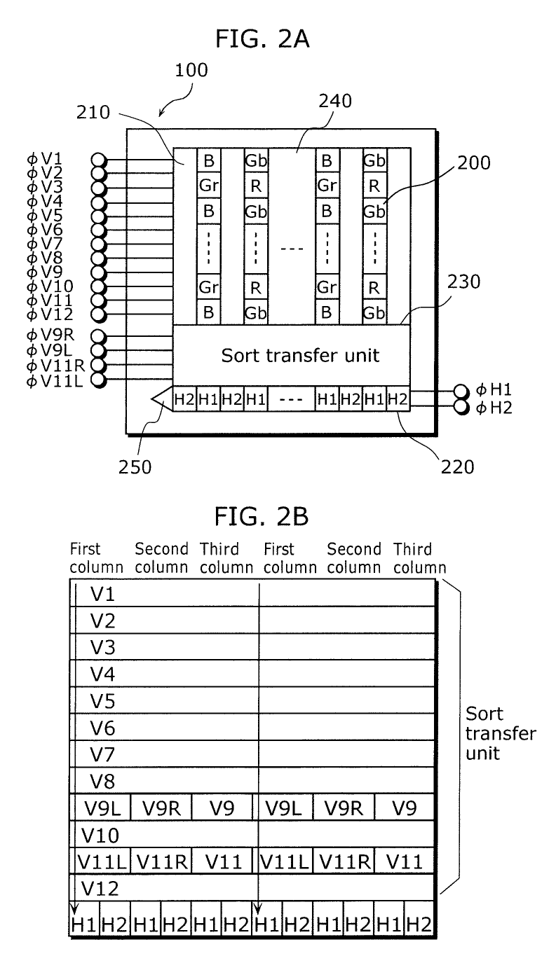

FIG. 2A is a schematic diagram of the solid-state imaging sensor 100 and FIG. 2B is a schematic diagram of a sort transfer unit 230.

The solid-state imaging sensor 100 includes: plural photo diodes 200; plural column CCDs 210; a row CCD 220; and a charge detection unit 250, as shown in FIG. 2A.

Plural photo diodes 200 which are an example of a photoelectric conversion element of the present invention are two-dimensionally arranged (arranged in a matrix) in association with pixels. Three color filters, a red (R), a green (G), and a blue (B), are respectively arranged on the photo diodes 200. The column CCDs 210 are an example of a column transfer unit of the present invention and include a CCD having drive electrodes V1 to V12, V9R, V9L, V11R, and V11L. The column CCDs 210 transfers signal charge generated in the photo diodes 200 in a column direction according to application of the driving pulses φV1 to φV12, φV9R, φV9L, φV11R, and φV11L.

The row CCD 220 which is an example of a row transfer unit includes a CCD having drive electrodes H1 and H2 and transfers the signal charge transferred by the column CCDs 210 in a row direction according to application of the driving pulses φH1 and φH2.

A sort transfer unit 230 which controls reading of signal charge from the column CCDs 210 to the row CCD 220 separately for each column is formed on the final stage of the column CCDs 210 closest to the row CCD 220, which is between the row CCD 220 and an imaging unit 240 in which the photo diodes 200 and the column CCDs 210 are formed.

The sort transfer unit 230 has the same electrode structure for every three columns as shown in FIG. 2B. More specifically, the sort transfer unit 230 in the first column CCD 210 includes the drive electrodes V1, V2, V3, V4, V5, V6, V7, V8, V9L, V10, V11L, and V12. The sort transfer unit 230 in the second column CCD 210 includes the drive electrodes V1, V2, V3, V4, V5, V6, V7, V8, V9R, V10, V11R, and V12. The sort transfer unit 230 in the third column CCD 210 includes the drive electrodes V1, V2, V3, V4, V5, V6, V7, V8, V9, V10, V11, and V12. Here, the drive electrodes V1, V2, V3, V4, V5, V6, V7, V8, V10, and V12 are common electrodes shared by all of the columns, and the drive electrodes V9, V9R, V9L, V11, V11R, and V11L are independent electrodes separated in an island shape in each of the columns. The drive electrodes V9 and V11 are independent electrodes separated in an island shape in the sort transfer unit 230, and are common electrodes shared by all of the columns in the column CCDs 210 excepting the sort transfer unit 230.

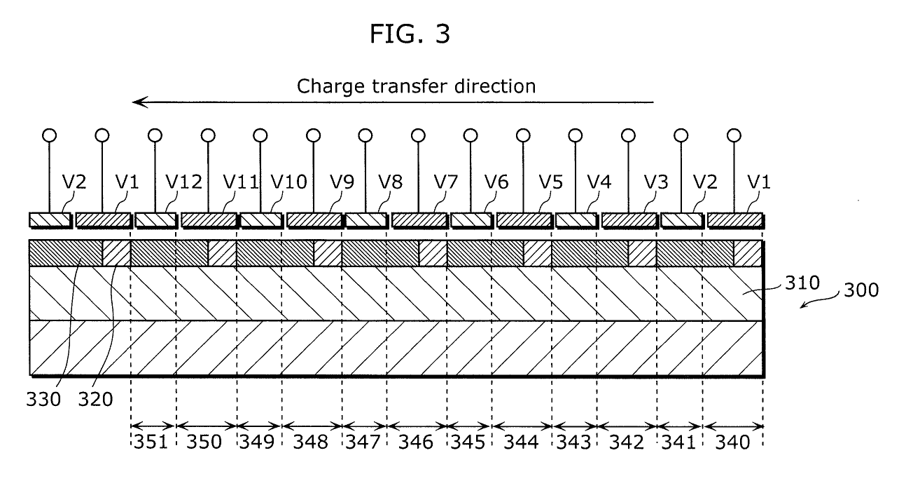

FIG. 3 is a sectional view which shows a structure of the second column CCD 210.

When two adjacent drive electrodes of the column CCDs 210 are compared, one is longer than the other in a charge transfer direction. More specifically, the lengths of drive electrodes V1, V3, V5, V7, V9, and V11 in the charge transfer direction is longer than the lengths of drive electrodes V2, V4, V6, V8, V10, and V12 in the charge transfer direction. This enlarges the area of a transfer electrode which is provided on a read path of the signal charge of the photo diodes 200 and to which read voltage of the signal charge of the photo diodes 200; that is, the potential V_{H} is applied. As a result, it is possible to ensure a read channel width necessary for reading the signal charge even when a pixel is miniaturized.

A p-type substrate 300 is provided under the drive electrodes V1 to V12. An n-type dopant region 310 is formed as a part of the column CCDs 210 in the substrate 300. An n⁺-type dopant region 320 more densely-doped than the dopant region 310 and an n⁻-type dopant region 330 less densely-doped than the dopant region 310 are formed through uneven doping of an impurity to the dopant region 310. These dopant regions include 12 cyclic charge transfer stages that operate as a barrier region or a well region of potential according to a voltage application of the drive electrodes V1 to V12. More specifically, a first charge transfer stage 340 provided with the drive electrode V1, a second charge transfer stage 341 provided with the drive electrode V2, a third charge transfer stage 342 provided with the drive electrode V3, a forth charge transfer stage 343 provided with the drive electrode V4, a fifth charge transfer stage 344 provided with the drive electrode V5, a sixth charge transfer stage 345 provided with the drive electrode V6, a seventh charge transfer stage 346 provided with the drive electrode V7, an eighth charge transfer stage 347 provided with the drive electrode V8, a ninth charge transfer stage 348 provided with the drive electrode V9, a tenth charge transfer stage 349 provided with the drive electrode V10, an eleventh charge transfer stage 350 provided with the drive electrode V11, and a twelfth charge transfer stage 351 provided with the drive electrode V12 are included. Therefore, these dopant regions function as column charge transfer paths (VCCD) that transfer the signal charge.

Since the dopant region 310 includes, under each of the drive electrodes V1, V3, V5, V7, V9, and V11, dopant regions 320 and 330 each of which has different dopant density, the first charge transfer stage 340, the third charge transfer stage 342, the fifth charge transfer stage 344, the seventh charge transfer stage 346, the ninth charge transfer stage 348, and the eleventh charge transfer stage 350 operate as the barrier region and the well region in which the potential shape is inclined in the charge transfer direction.

It is to be noted that the first and the third column CCDs 210 have the same structure as shown in FIG. 3, except that one of the drive electrodes V9 changes into V9R or V9L and one of the drive electrodes V11 changes into V11R or V11L.

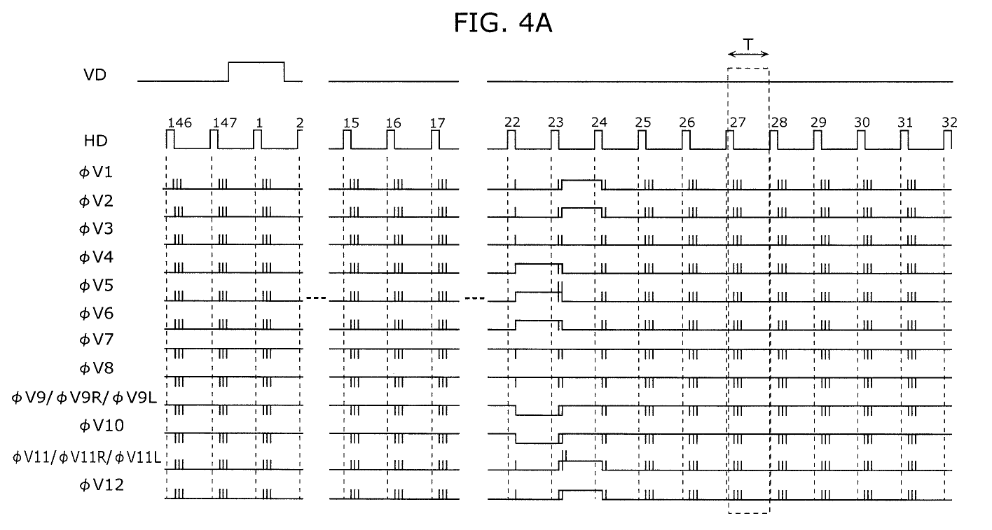

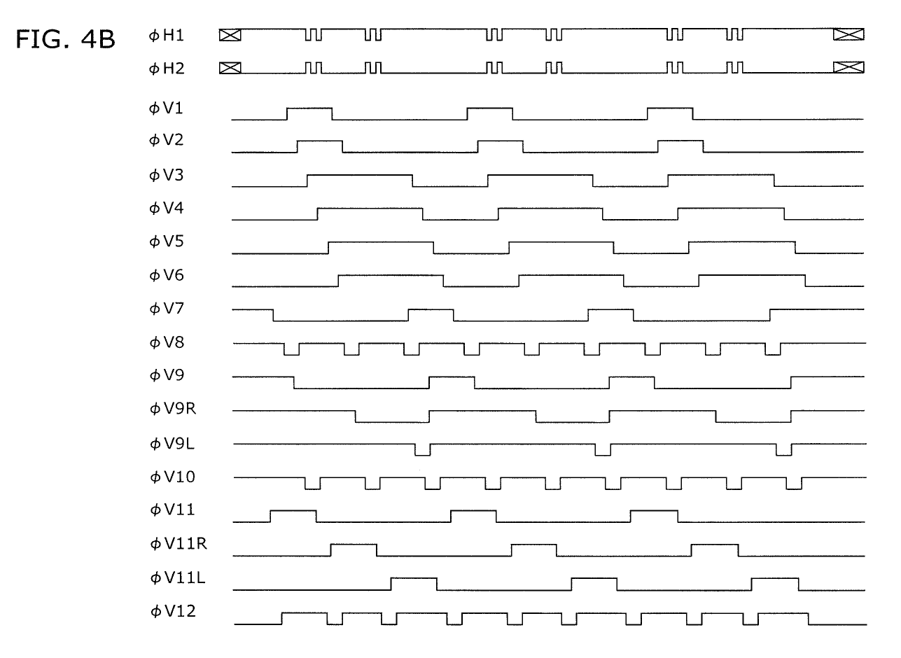

FIG. 4A and FIG. 4B show timing of 60 fps monitoring mode in the solid-state imaging device which has the above structure. FIG. 4A shows timing with which signals for one image are outputted in 1/60 seconds. A single image is outputted in response to the column synchronization signal VD and the row CCD 220 performs charge transfer operation once in response to the row synchronization signal HD. FIG. 4B is an enlarged view of a time period T of FIG. 4A. Timing for transferring to the row CCD 220, transferring in the row direction, and outputting signals for three lines is shown.

According to this timing, a single transfer packet is formed using a twelve-phase drive of the drive electrodes V1 to V12. For a single packet formed using a six-phase drive of the drive electrodes V1 to V6 and V7 to V12, the density of the transfer packet is half the density of the transfer packet formed using the twelve-phase drive. The transfer in the column direction is speeded up using this timing.

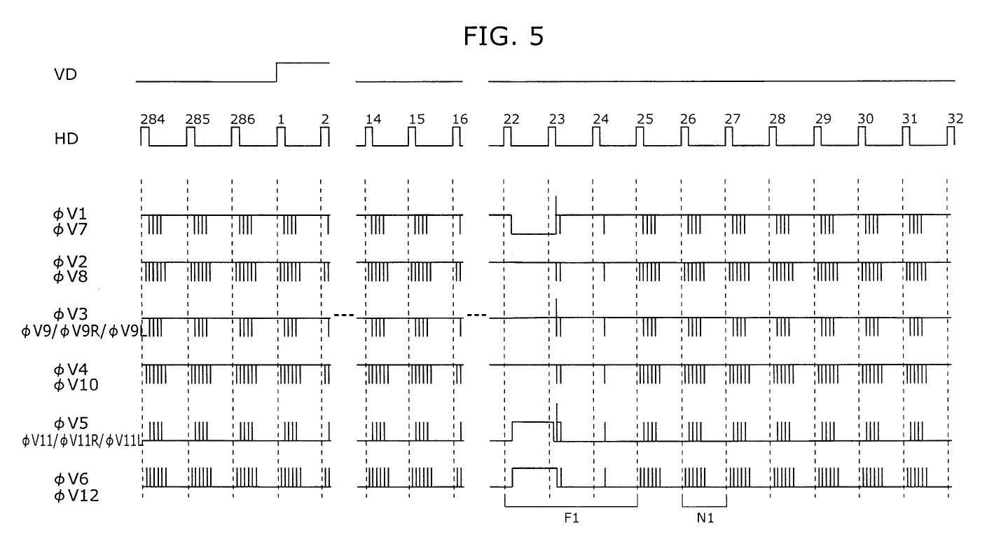

FIG. 5 shows a timing of 30fps monitoring mode of the six-phase drive in the solid-state imaging device which has the above structure. In other words, FIG. 5 shows timing with which signals for a single image is outputted in 1/30 seconds.

According to this timing, a single transfer packet is formed using the six-phase drive of the drive electrodes V1 to V6 and V7 to V12. For a single packet formed using the twelve-phase drive of the drive electrodes V1 to V12, the density of the transfer packet is twice as dense as the density of the transfer packet formed using the twelve-phase drive. This timing makes it possible to achieve video driving of a higher image quality.

The number of transfer packets is increased using the six-phase drive to output a high-definition image when video recording of a higher image quality is required, and the twelve-phase drive as shown in FIG. 4A and FIG. 4B is used to achieve high-speed transfer in a mode which requires high-speed processing as a camera, such as an automatic focus and an exposure adjustment.

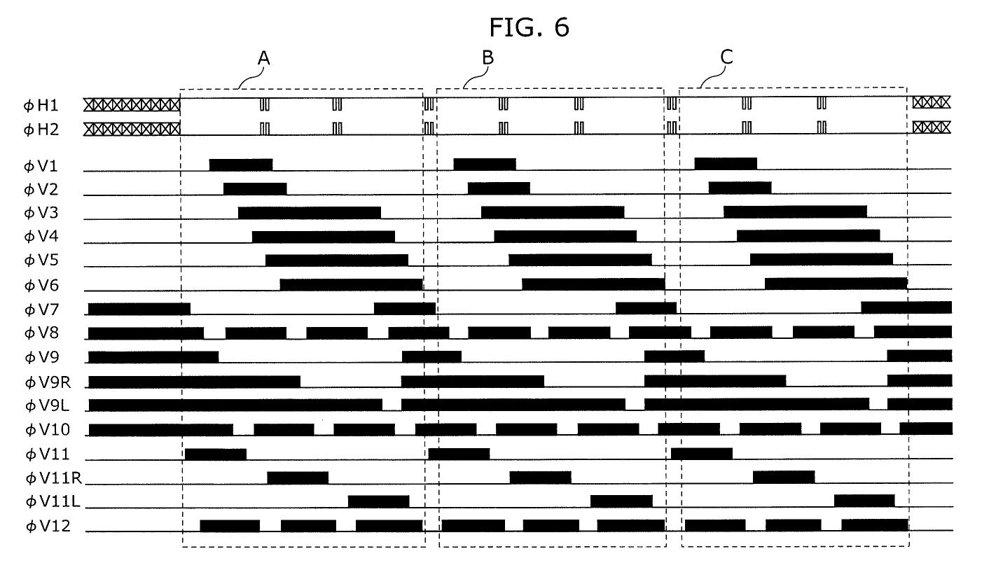

FIG. 6 shows a method of transferring a packet in the column CCDs 210 and the row CCD 220 which have the above structure according to the timing of FIG. 4A.

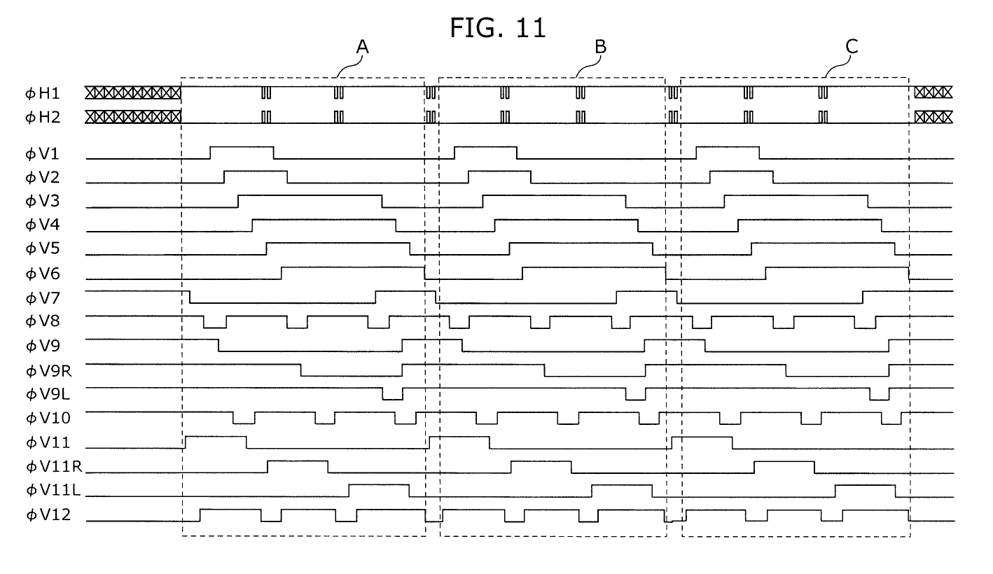

FIG. 11 shows timing of the packet transfer method as shown in FIG. 6. It is to be noted that the transfer method is an example of driving method of the solid-state imaging device of the present invention.

In a period A as shown in FIG. 6, a single packet of the column CCDs 210 is transferred to the row CCD 220. After two stage transfer in the row CCD 220 is performed, another one packet is transferred to the row CCD 220 in a period B as shown in FIG. 6. Similarly, after yet another single packet is transferred to the row CCD 220 in a period C as shown in FIG. 6, a charge of the row CCD 220 is transferred. After a total of three packets are transferred to the row CCD 220, a waiting period appears in which the transfer in the column direction is halted. At this time, a transfer time of the row CCD 220 is longer than a transfer time of the column CCD 210.

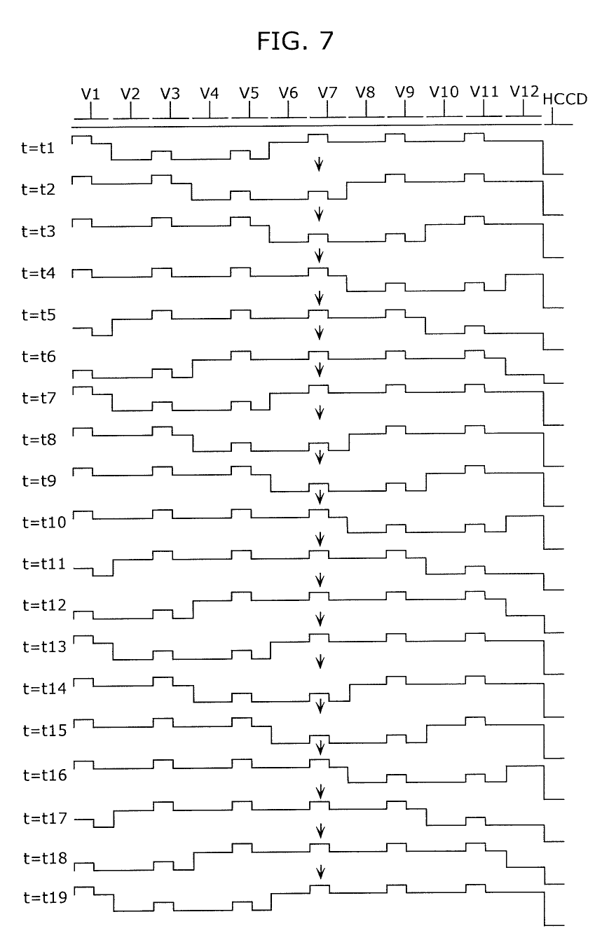

FIG. 7 is a variation diagram of a potential distribution (a variation diagram of a potential distribution in the second column CCD 210) which shows a method of transferring a packet in the column CCDs 210 that has the above structure. It is to be noted that the transfer method is an example of the driving method of the solid-state imaging device of the present invention.

A single packet of the second column CCD 210 is transferred to the row CCD 220 at times t1 to t7. After that, although not illustrated, the transferred packet is transferred for two pixels in the row direction, and a single packet of the third column CCD 210 is transferred to the row CCD 220. After the transferred packet is transferred for two pixels in the row direction, a single packet of the first column CCD 210 is transferred to the row CCD 220.

Similarly at the times t8 to t13 and at the times t14 to t19, a single packet of the third and the first column CCDs 210 are transferred to the row CCD 220, after a single packet of the second column CCD 210 is transferred to the row CCD 220. Accordingly, three packets in each of the column CCDs 210 are consecutively transferred to the row CCD 220.

At time t19, a low-level potential V_{L} is applied to the drive electrode V1 and the column CCDs 210 are controlled so that the charge transfer stages that operate as the barrier region are eight adjacent stages in the twelve charge transfer stages, and then the transfer in the column direction is halted. Among the eight adjacent charge transfer stages, the charge transfer stage positioned most downstream is a charge transfer stage that operates as the barrier region in which the potential shape is inclined in the charge transfer direction (the stage which corresponds to the drive electrode V1). The waiting period during which the transfer is halted, that is, the waiting period during which the charge transfer is halted due to a break after transferring the three packets is longer than the transfer period during which the charge transfer using a single packet is performed (times t1 to t7, times t8 to t13, or times t14 to t19). Subsequently, plural packets in the row CCD 220 are transferred to the charge detection unit 250. It is to be note that, in the third and the first column CCDs 210 as well, the charge transfer stages that operate as the barrier region are arranged to be eight adjacent stages in the twelve charge transfer stages during the waiting period.

The signal charge of three pixels are mixed in the row direction in the row CCD 220 by applying each of the driving pulses to the column CCDs 210 and the row CCD 220 and driving the column CCDs 210 and the row CCD 220 such that the above packet transfer is performed.

As described above, according to the camera of the present embodiment, charge transfer stages that operate as the barrier region are arranged to be eight adjacent stages in the twelve charge transfer stages during the waiting period. Among the eight adjacent charge transfer stages, the charge transfer stage positioned most downstream is a charge transfer stage that operates as the barrier region in which the potential shape is inclined in the charge transfer direction (the stage which corresponds to the drive electrode V1). Therefore, the charge transfer stage positioned most downstream operates as the barrier region and the well region in which the potential shape is inclined in the charge transfer direction and the signal charge is less likely to be trapped or not trapped in the transfer-degraded spot, so that unevenness in the signal charge amount can be reduced. Further, during the waiting period, signal charge trapped in a spot positioned between barriers in adjacent charge transfer stages that operate as the barrier region are not added to the adjacent well region from the transfer-degraded spot. Therefore, the amount of signal charge transferred by the signal charge trapped in the transfer-degraded spot between stages does not vary, so that pixel mixture can be performed in the row CCD without causing quality deterioration such as unevenness in an image.

Further, according to the camera of the present embodiment, transfer operation is halted after plural packets are transferred. For the reason described above, the amount of signal charge transferred does not vary even after the transfer operation is resumed. Therefore, it is possible to perform image stabilization and electronic zooming without causing quality deterioration such as unevenness in an image.

Further, in a solid-state imaging device with an electric image stabilization (EIS) function, for example, a transfer operation is halted after plural packets are transferred. Therefore, the solid-state imaging device and the method thereof according to the embodiment of the present invention can also prevent quality deterioration such as unevenness in an image for the solid-state imaging device with the EIS function by utilizing the packet transfer according to the present embodiment for the solid-state imaging device with the EIS function.

Further, according to the camera of the present embodiment, it is possible to minimize the area of the well region by having a minimum necessary number of charge transfer stages that operate as the well region for controlling the charge transfer, thereby suppressing increase of dark current and degradation of transfer efficiency when the signal amount is low.

Further, according to the camera of the present embodiment, a dopant concentration distribution in which the potential decreases toward an adjacent charge transfer stage is formed in the charge transfer stage that operates as the barrier region during a waiting period. Therefore, the charge transfer stage operates as the barrier region and the well region in which the potential shape is inclined in the charge transfer direction. As a result, the signal charge is less likely to be trapped or not trapped in the transfer-degraded spot, so that unevenness in the signal charge amount can further be reduced.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

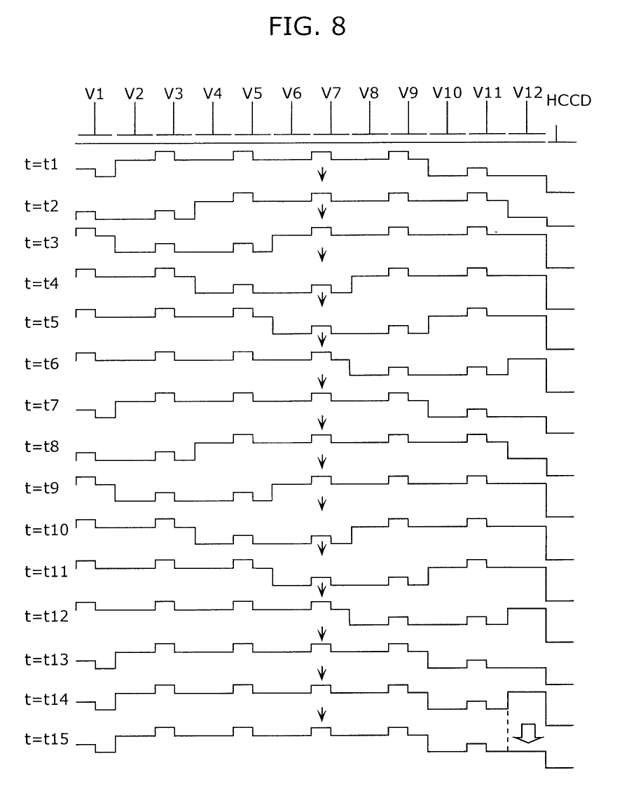

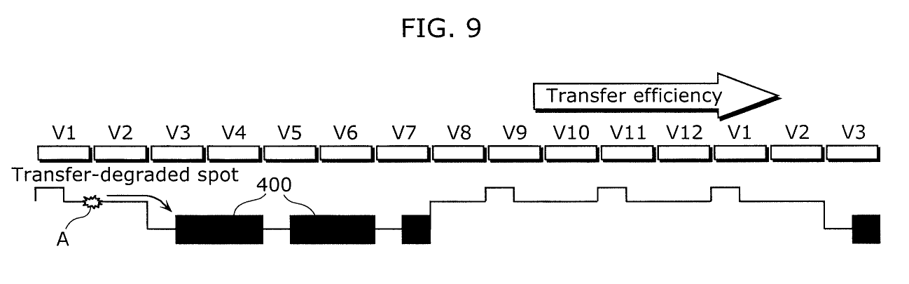

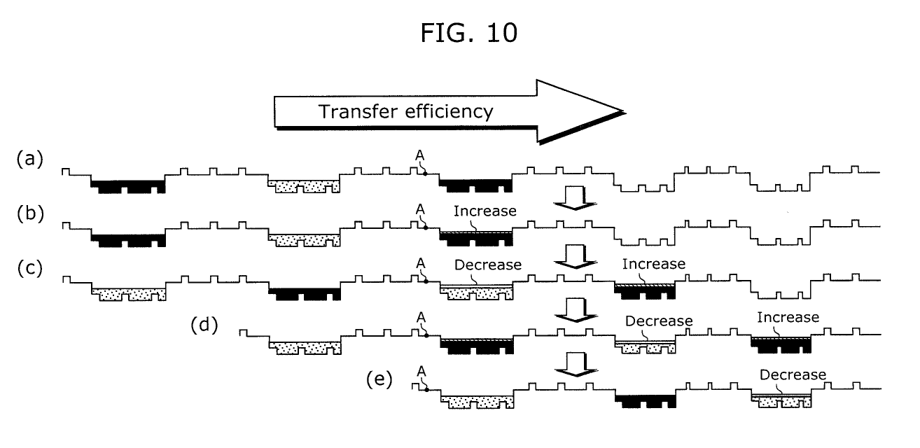

For example, in the camera of the present embodiment, the charge transfer may be performed such that the charge transfer stage positioned closest to the row CCD, among charge transfer stages that operate as the barrier region during in the waiting period, operates as the well region in the waiting period after operating as the barrier region. This provides a greater potential difference between the row CCD and the final stage of the column CCDs, so that a single packet can be transferred to the row CCD without causing residual transfer charge, thereby preventing degradation of transfer efficiency between the row CCD and the column CCDs. In this case, packet transfer is performed according to the variation diagram of the potential distribution in FIG. 8 (the variation diagram of the potential distribution of the second column CCD 210). This transfer is different from the packet transfer as shown in FIG. 7 in that a low-level potential V_{L} is applied to the drive electrode V12 at the time t14 after the time t13 to cause the charge transfer stage in which the drive electrode V12 is formed to operate as the barrier region, and then a middle-level potential V_{M} is applied to the drive electrode V12 at the time t15 to cause the charge transfer stage in which the drive electrode V12 is formed to operate as the well region.

Further, in the embodiment described above, the column CCDs are assumed to be twelve-phase drive CCDs including the transfer electrodes V1 to V12. However, the CCD is not limited to the above, as long as the packet transfer of the above embodiment is applicable, that is, as long as the CCD includes at least seven charge transfer stages and at least seven-phase driving pulse is applied. For example, seven-phase drive CCD may be used. In this case, charge transfer is performed such that at least three adjacent charge transfer stages, among seven or more charge transfer stages, operate as the barrier region in waiting period. The three adjacent stages include two charge transfer stages that operate as the barrier region in which the potential shape is inclined in the charge transfer direction and a single charge transfer stage which is positioned between the two charge transfer stages and operates as the barrier region in which the potential shape is not inclined in the charge transfer direction. Among the three adjacent charge transfer stages, the charge transfer stage positioned most downstream (the most downstream charge transfer stage) is a charge transfer stage that operates as the barrier region in which the potential shape is inclined in the charge transfer direction.

Further, in the above embodiment, the inclined potential shape is assumed to be formed through uneven doping of an impurity to the dopant region. However, the inclined potential shape may be formed by using a narrow channel effect which expands a channel width of charge transfer toward a transfer direction.

### INDUSTRIAL APPLICABILITY

The present invention can be utilized for a solid-state imaging device, and in particular for a CCD solid-state imaging device and the like which perform pixel mixture.

What is claimed is:

1. A solid-state imaging device comprising:
a plurality of photoelectric conversion elements arranged two-dimensionally;
a plurality of column transfer units configured to transfer, in a column direction, charge generated in said photoelectric conversion elements;
a row transfer unit configured to transfer, in a row direction, the charge transferred by said column transfer units; and
a transfer control unit configured to control the charge transfer performed by said column transfer units,
wherein each of said column transfer units includes seven or more charge transfer stages each operating as a barrier region or a well region according to an applied voltage,
said charge transfer stages include a first charge transfer stage in which a potential shape is inclined in a charge transfer direction, and
said transfer control unit is configured to control the charge transfer performed by said column transfer units such that: said column transfer units consecutively transfer a plurality of packets each of which is the charge transferred in the well regions that are successive and segmentalized by the barrier regions; a waiting period in which the charge transfer of the packets is halted is longer than a transfer period in which the charge transfer of the packets is performed; said charge transfer stages which operate as the barrier region are at least three adjacent stages among said seven or more charge transfer stages in the waiting period; and said first charge transfer stage is positioned most downstream among said adjacent charge transfer stages which operate as the barrier region in the waiting period.

2. The solid-state imaging device according to claim 1,
wherein said column transfer units are configured to consecutively transfer the packets each of which is the charge transferred in the well regions that are successive and segmentalized by the barrier regions when pixel mixture is performed.

3. The solid-state imaging device according to claim 1,
wherein said column transfer units are configured to consecutively transfer the packets each of which is the charge transferred in the well regions that are successive and segmentalized by the barrier regions when image stabilization or electronic zooming is performed.

4. The solid-state imaging device according to claim 1,
wherein, in said first charge transfer stage, the inclined potential shape is formed through uneven doping of an impurity.

5. The solid-state imaging device according to claim 1,
wherein, in said first charge transfer stage, the inclined potential shape is formed utilizing a narrow channel effect which expands, toward a transfer direction, a channel width of the charge transfer.

6. The solid-state imaging device according to claim 1,
wherein said transfer control unit is configured to control the charge transfer performed by said column transfer units such that a charge transfer stage positioned closest to said row transfer unit, among said seven ore more charge transfer stages, operates as the well region after operating as the barrier region in the waiting period.

7. A method for driving a solid-state imaging device including: a plurality of photoelectric conversion elements arranged two-dimensionally; a plurality of column transfer units which transfer, in a column direction, charge generated in the photoelectric conversion elements; and a row transfer unit which transfer, in a row direction, the charge transferred by the column transfer units,
wherein each of the column transfer units includes seven or more charge transfer stages each operating as a barrier region or a well region according to an applied voltage,
the charge transfer stages includes a first charge transfer stage in which a potential shape is inclined in a charge transfer direction, and
the solid-state imaging device is driven such that: the column transfer units consecutively transfer a plurality of packets each of which is the charge transferred in the well regions that are successive and segmentalized by the barrier regions; a waiting period in which the charge transfer of the packets is halted is longer than a transfer period in which the charge transfer of the packets is performed; the charge transfer stages which operate as the barrier region are at least three adjacent stages among the seven or more charge transfer stages in the waiting period; and the first charge transfer stage is positioned most downstream among the adjacent charge transfer stages which operate as the barrier region in the waiting period.

8. The method for driving the solid-state imaging device according to claim 7,
wherein the column transfer units consecutively transfer the packets each of which is the charge transferred in the well regions that are successive and segmentalized by the barrier regions when pixel mixture is performed.

9. The method for driving the solid-state imaging device according to claim 7,
wherein the column transfer units consecutively transfer the packets each of which is the charge transferred in the well regions that are successive and segmentalized by the barrier regions when image stabilization or electronic zooming is performed.

10. A camera comprising a solid-state imaging device recited in claim 1.
